(19) United States
(12) Patent Application Publication
(10) Pub. No.: US 2024/0399894 A1
(43) Pub. Date: Dec. 5, 2024

(54) ENGINE-DRIVEN DC SUPPLY UNIT

(71) Applicant: YAMAHA HATSUDOKI KABUSHIKI KAISHA, Iwata-shi (JP)

(72) Inventors: Yasuhiro OKADA, Shizuoka (JP); Masafumi MASUDA, Shizuoka (JP)

(21) Appl. No.: 18/807,394

(22) Filed: Aug. 16, 2024

Related U.S. Application Data
(63) Continuation-in-part of application No. PCT/JP2022/006593, filed on Feb. 18, 2022.

(51) Int. Cl. B60L 50/52; B60L 50/60

(52) U.S. Cl. CPC B60L 50/52; B60L 50/66; B60L 2210/12

(57) ABSTRACT

An engine-driven-DC-supply unit, including: an electric generator; an engine driving the electric generator; an electric power converter that converts the electric power generated by the electric generator driven by the engine to DC power; a controller that controls the electric power converter and/or the engine; a controller-housing case that houses at least the controller; a base member that directly or indirectly supports the electric generator, the engine, the electric power converter, and the controller; and an electric-equipment-housing-case supporter disposed in at least one of the electric generator, the engine, the controller-housing case, or the base member, and supporting an electric-equipment-housing case. The electric-equipment-housing case is free of contact with an external load device, when the engine-driven-DC-supply unit is electrically connected to the external load device. The relay circuit, the DC-to-DC converter and the external communication equipment is disposed entirely either in the electric-equipment-housing case or on the external load device.

### CROSS-REFERENCES TO RELATED APPLICATIONS

This is a continuation-in-part application of International Application No. PCT/JP2022/006593 filed on Feb. 18, 2022, the contents of which are incorporated herein by reference.

### TECHNICAL FIELD

The present teaching relates to an engine-driven-DC-supply unit.

### BACKGROUND ART

A known engine-driven-direct-current (DC)-supply unit converts electric power output from an electric generator driven by an engine to DC power by an electric power converter and outputs the converted DC power. This engine-driven-DC-supply unit is a unit without supplying mechanical power to an external load device. As such an engine-driven-DC-supply unit, Patent Document 1, for example, discloses an engine-generator-mounted structure for an automobile including an electric generator and an engine for driving the electric generator.

In the engine-generator-mounted structure disclosed in Patent Document 1, the electric power converter converts electric power generated by the electric generator driven by the engine to DC power, and a battery is charged with the DC power. A vehicle including the engine-generator-mounted structure includes a motor that rotationally drives drive wheels with electric power supplied from the battery.

The vehicle travels by driving the motor with electric power previously charged to the battery in short-distance travel, whereas at deceleration of the vehicle, the battery is charged with regenerated energy generated by the motor. The vehicle is configured such that when capacity of the battery decreases to a predetermined level or less during long-distance travel, the engine drives the electric generator, and the generated electric power is supplied to the battery to charge the battery.

### CITATION LIST

### Patent Document

Patent Document 1: Japanese Patent Application Publication No. 2016-78622

### SUMMARY OF INVENTION

The engine-driven-DC-supply unit as described above is a unit without providing mechanical power to the external load device. Thus, the engine-driven-DC-supply unit, without a need to transfer mechanical power to the external load device, only needs to be connected to the external load device such that the engine-driven-DC-supply unit can supply DC power to the external load device. Accordingly, the engine-driven-DC-supply unit can supply DC power to the external load device including various DC loads, and therefore, is versatile.

At least one of the external load device or the engine-driven-DC-supply unit needs a precharge-function-equipped-main relay, a DC-to-DC converter, and communication equipment for communication with the outside. These functions need to be provided to avoid an overlap between the external load device and the engine-driven-DC-supply unit. However, Patent Document 1 fails to disclose that the above-mentioned functions are provided to avoid an overlap between the vehicle body and the unit.

In addition, the mode of the external load device varies depending on required specifications and applications. Specifically, which of the precharge-function-equipped-main relay, the DC-to-DC converter, or the communication device with a user the external load device includes varies depending on the type of the external load device. In view of this, it is desired to enhance versatility of the engine-driven-DC-supply unit such that the engine-driven-DC-supply unit can supply DC power to various types of external load devices.

It is therefore an object of the present teaching to provide an engine-driven-DC-supply unit without mechanical power transfer capable of enhancing versatility of the engine-driven-DC-supply unit to enable supply of DC power to various types of external load devices.

### Solution to Problem

The inventors of the present teaching studied a structure of an engine-driven-DC-supply unit without mechanical power transfer capable of enhancing versatility of the engine-driven-DC-supply unit to enable supply of DC power to various types of external load devices. Through an intensive study, the inventors arrived at the following configurations.

An engine-driven-DC-supply unit according to one embodiment of the present teaching is an engine-driven-DC-supply unit including: an electric generator; an engine that drives the electric generator to generate electric power; an electric power converter that converts the electric power generated by the electric generator to DC power, and outputs the DC power to an external load device located outside the engine-driven-DC-supply unit; a controller that controls at least one of the electric power converter or the engine; a controller-housing case that houses at least the controller; a base member that directly or indirectly supports the electric generator, the engine, the electric power converter, and the controller; and an electric-equipment-housing-case supporter disposed in at least one of the electric generator, the engine, the controller-housing case, or the base member, wherein the engine-driven-DC-supply unit supplies the DC power to the external load device without providing mechanical power for driving the external load device.

The electric-equipment-housing-case supporter supports an electric-equipment-housing case that is configured as a case different from the controller-housing case and houses electric equipment electrically connected to the controller. The electric equipment is at least one of a relay circuit including a precharge circuit, a DC-to-DC converter that converts the DC power to DC power of a different voltage, or external communication equipment configured to communicate with another external equipment different from the engine-driven-DC-supply unit and the external load device by wireless connection or wired connection. The electric-equipment-housing-case supporter is so disposed that the electric-equipment-housing case is supported to be free of contact with the external load device, in a case where the engine-driven-DC-supply unit is electrically connected to the external load device, and each of the relay circuit, the DC-to-DC converter and the external communication equipment is disposed entirely either in the electric-equipment-housing case or on the external load device.

With this configuration, the electric-equipment-housing-case supporter disposed in at least one of the electric generator, the engine, the controller-housing case, or the base member can support the electric-equipment-housing case housing at least one of the relay circuit, the DC-to-DC converter, or the external communication equipment while avoiding an overlap of the relay circuit, the DC-to-DC converter, and the external communication equipment depending on whether the relay circuit, the DC-to-DC converter, and the external communication equipment are mounted on the external load device, at a position at which the electric-equipment-housing case is free of contact with the external load device. That is, the electric-equipment-housing case houses at least one of the relay circuit, the DC-to-DC converter, or the external communication equipment to avoid an overlap with electric equipment disposed in the external load device. The electric-equipment-housing-case supporter may not support the electric-equipment-housing case to avoid an overlap with the electric equipment disposed in the external load device. That is, the engine-driven-DC-supply unit may not include the electric-equipment-housing case.

Thus, the configuration of the engine-driven-DC-supply unit can be easily changed depending on the type, required specifications, and other characteristics of the external load device. As a result, versatility of the engine-driven-DC-supply unit can be enhanced to enable supply of DC power to various types of external load devices.

In another aspect, the engine-driven-DC-supply unit according to the present teaching preferably includes the following configuration. The engine-driven-DC-supply unit supplies the DC power to an electric power storage or an electrical load included in the external load device.

With this configuration, the electric power storage or the electrical load included in

the external load device is supplied with DC power by the engine-driven-DC-supply unit. In this manner, the engine-driven-DC-supply unit can supply DC power to various types of the external load device. As a result, highly versatile engine-driven-DC-supply unit can be obtained.

In another aspect, the engine-driven-DC-supply unit according to the present teaching preferably includes the following configuration. Each of the electric power storage and the electrical load is supported by the external load device, without being supported by the base member.

This configuration can reduce the size of the engine-driven-DC-supply unit. Thus, it is possible to reduce the size of the engine-driven-DC-supply unit with high versatility capable of supplying DC power to various types of external load devices.

In another aspect, the engine-driven-DC-supply unit according to the present teaching preferably includes the following configuration. The engine-driven-DC-supply unit further includes an external-load-device controller that controls the electric equipment mounted on the external load device, the external-load-device controller being unsupported by the base member.

This configuration can reduce the size of the engine-driven-DC-supply unit. Thus, it is possible to reduce the size of the engine-driven-DC-supply unit with high versatility capable of supplying DC power to various types of external load devices.

In another aspect, the engine-driven-DC-supply unit according to the present teaching preferably includes the following configuration. The controller has both an engine control function of controlling the engine and an electric-power-conversion-controlling function of controlling the electric power converter, and is housed in the controller-housing case. The engine-driven-DC-supply unit further includes a controller-housing-case supporter supporting the controller-housing case. The electric-equipment-housing case is connected to the base member by the electric-equipment-housing-case supporter through an elastic member, and the controller-housing case is connected to the base member by the controller-housing-case supporter without using the elastic member as an intermediary thereof, or the electric-equipment-housing case is connected to the base member by the electric-equipment-housing-case supporter without using the elastic member as an intermediary thereof, and the controller-housing case is connected to the base member by the controller-housing-case supporter through the elastic member.

With this configuration, since one of the electric-equipment-housing case and the controller-housing case is supported through the elastic member, in a case where a force, vibrations, or the like is input to the electric-equipment-housing case and the controller-housing case, the electric-equipment-housing case and the controller-housing case exhibit different movements. That is, the electric-equipment-housing case and the controller-housing case are supported to exhibit different movements upon receiving a force, vibrations, or the like. Thus, in the configuration described above, a member with high support rigidity enough to support both the electric-equipment-housing case and the controller-housing case is unnecessary.

In general, since a DC electric generator has high output, the sizes of an electric-equipment-housing case and a controller-housing case for the DC electric generator are large. Thus, in enhancing versatility of the engine-driven-DC-supply unit, the electric-equipment-housing case, the controller-housing case, and a structure supporting these cases tend to be an obstacle.

On the other hand, in the configuration described above, since a part with high support rigidity enough to support both the electric-equipment-housing case and the controller-housing case is unnecessary, the size of parts supporting the electric-equipment-housing case and the controller-housing case can be reduced. Accordingly, the configuration of the engine-driven-DC-supply unit including the electric-equipment-housing case and the controller-housing case can be made compact.

In another aspect, the engine-driven-DC-supply unit according to the present teaching preferably includes the following configurations. The controller has both an engine control function of controlling the engine and an electric-power-conversion-controlling function of controlling the electric power converter, and is housed in the controller-housing case The engine-driven-DC-supply unit further includes a controller-housing-case supporter supporting the controller-housing case. The electric-equipment-housing case is connected to the base member by the electric-equipment-housing-case supporter through an elastic member, and the controller-housing case is connected to the base member by the controller-housing-case supporter through the elastic member, or the electric-equipment-housing case is connected to the base member by the electric-equipment-housing-case supporter without using the elastic member as an intermediary thereof, and the controller-housing case is connected to the base member by the controller-housing-case supporter without using the elastic member as an intermediary thereof.

With this configuration, since the electric-equipment-housing case and the controller-housing case are supported through the elastic member or without using the elastic member as an intermediary thereof, in a case where a force, vibrations, or the like is input to the electric-equipment-housing case and the controller-housing case, the electric-equipment-housing case and the controller-housing case exhibit similar movements. Thus, the electric-equipment-housing case and the controller-housing case can be electrically connected directly to each other by, for example, a bus bar.

As described above, to enhance versatility of the engine-driven-DC-supply unit, the electric-equipment-housing case and the controller-housing case tend to be an obstacle.

On the other hand, the configuration described above enables a component housed in the electric-equipment-housing case and a component housed in the controller-housing case to be electrically connected to each other with a simple and compact structure. Thus, the configuration of the engine-driven-DC-supply unit including the electric-equipment-housing case and the controller-housing case can be made compact.

In another aspect, the engine-driven-DC-supply unit according to the present teaching preferably includes the following configurations. The electric-equipment-housing-case supporter is so disposed that the electric-equipment-housing case is supported at a position that is without hindering attachment and detachment of the base member to/from the external load device in a case where the engine-driven-DC-supply unit is attached to the external load device.

With this configuration, the electric-equipment-housing-case supporter supports the electric-equipment-housing case without hindering attachment and detachment of the base member to/from the external load device. Thus, it is possible to obtain the engine-driven-DC-supply unit with enhanced mountability to various types of external load devices.

In another aspect, the engine-driven-DC-supply unit according to the present teaching preferably includes the following configuration. The engine-driven-DC-supply unit further includes a controller-housing-case supporter disposed in at least one of the electric generator, the engine, or the base member such that the controller-housing case is supported at a position at which the controller-housing case is free of contact with the external load device in a case where the engine-driven-DC-supply unit is attached to the external load device. The electric-equipment-housing-case supporter is so disposed that the electric-equipment-housing case is supported at a position at which the electric-equipment-housing case is attachable to and detachable from the electric-equipment-housing-case supporter even in a state where the controller-housing-case supporter supports the controller-housing case.

With this configuration, in a state where the controller-housing-case supporter supports the controller-housing case, the electric-equipment-housing case can be mounted on or attached/detached to/from the electric-equipment-housing-case supporter. Thus, the configuration of the engine-driven-DC-supply unit can be easily changed depending on the type, required specifications, and other characteristics of the external load device. Thus, it is possible to obtain the engine-driven-DC-supply unit with enhanced mountability to various types of external load devices.

The terminology used herein is for the purpose of describing particular embodiments only and is not intended to be limiting of the invention.

As used herein, the term “and/or” includes any and all combinations of one or more of the associated listed items.

It will be further understood that the terms “including,” “comprising” or “having” and variations thereof when used in this specification, specify the presence of stated features, steps, operations, elements, components, and/or their equivalents but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Embodiments of an engine-driven-DC-supply unit according to the present teaching will be herein described.

In the following description, numerous specific details are set forth in order to provide a thorough understanding of the present invention. It is obvious that those skilled in the art, however, would be able to carry out the present invention without these specific examples.

The present disclosure is to be, therefore, considered as an exemplification of the invention, and is not intended to limit the invention to the specific embodiments illustrated by the figures or description below.

### Engine-Driven-DC-supply Unit

An engine-driven-DC-supply unit herein is a unit that includes an engine, an electric generator, and an electric power converter, converts electric power output from the electric generator driven by the engine to DC power by the electric power converter, and outputs the converted DC power. That is, the engine-driven-DC-supply unit is a unit without providing mechanical power to an external load device. The engine-driven-DC-supply unit is mountable or detachable to/from the external load device by using a base member. The engine-driven-DC-supply unit may be used as a power generating unit that, without being attached to the external load device, outputs DC power while being placed on the base, the ground, or the like.

### Precharge Circuit

A precharge circuit herein is a circuit that causes a current to flow to a condenser or other devices beforehand to charge the condenser or other devices in order to prevent occurrence of an inrush current when an electromagnetic contactor or an electromagnetic switch is turned on to establish an electric-power-supply state. The precharge circuit may be disposed in, for example, the electromagnetic contactor or the electromagnetic switch, or may be disposed separately from the electromagnetic contactor or the electromagnetic switch.

### Relay Circuit

A relay circuit herein is a circuit including a relay that electrically connects or disconnects a battery and an electric power converter. The relay circuit includes a precharge circuit. Examples of the relay include an electromagnetic contactor and an electromagnetic switch.

### External Load Device

An external load device herein refers to a device that receives DC power without receiving mechanical power from an engine-driven-DC-supply unit. Examples of the external load device include an electric power storage and a driving load. The “external” means a region other than the engine-driven-DC-supply unit.

### External Equipment

External equipment herein refers to equipment other than an external load device and an engine-driven-DC-supply unit. The “external” refers to a region other than the external load device and the engine-driven-DC-supply unit.

### Outside Engine-Driven-DC-Supply Unit

The expression “outside an engine-driven-DC-supply unit” herein refers to equipment, a configuration, and so forth other than the engine-driven-DC-supply unit. The expression “outside the engine-driven-DC-supply unit” includes an external load device to which the engine-driven-DC-supply unit is mounted.

### Directly or Indirectly Support

The expression “directly support a part, a device, or the like” means that a support member directly supports the part, the device, or the like. The expression “indirectly support a part, a device, or the like” means that a support member supports the part, the device, or the like through another part or the like.

### Advantageous Effects of Invention

According to one embodiment of the present teaching, it is possible to provide an engine-driven-DC-supply unit without mechanical power transfer capable of enhancing versatility of the engine-driven-DC-supply unit to enable supply of DC power to various types of external load devices.

### BRIEF DESCRIPTION OF DRAWINGS

FIG. 1 is a view illustrating an example of a schematic configuration of an engine-driven-DC-supply unit according to a first embodiment.

FIG. 2 is a functional block diagram illustrating an example of the schematic configuration of the engine-driven-DC-supply unit according to the first embodiment.

FIG. 3 is a functional block diagram illustrating an example of another configuration of the engine-driven-DC-supply unit.

FIG. 4 is a side view schematically illustrating a vehicle as an example of an external load device on which the engine-driven-DC-supply unit according to the first embodiment is mounted.

FIG. 5 is a side view schematically illustrating a state where the engine-driven-DC-supply unit according to the first embodiment placed on the ground or the like supplies electric power to a battery as an example of an external load device.

FIGS. 6A through 6H are views each schematically illustrating an example of layout of the engine-driven-DC-supply unit.

FIG. 7 is a side view illustrating a specific layout example of the engine-driven-DC-supply unit illustrated in FIG. 6A.

FIGS. 8A1 to 8C4 show views each illustrating an example of a mobile object on which the engine-driven-DC-supply unit is mounted where a relay circuit, a DC-to-DC converter, and external communication equipment are arranged to avoid an overlap depending on whether the relay circuit, the DC-to-DC converter, and the external communication equipment are mounted on the mobile object.

FIG. 9 is a functional block diagram illustrating an example of another configuration of the engine-driven-DC-supply unit.

FIGS. 10A through 10F are views each schematically illustrating an example of a configuration of an engine-driven-DC-supply unit according to a third embodiment.

FIGS. 11A through 11H are views each schematically illustrating an example of layout of an engine-driven-DC-supply unit according to a fourth embodiment.

FIG. 12 is a perspective view illustrating an example of layout of an engine-driven-DC-supply unit according to a fifth embodiment.

FIG. 13 is a top view of the engine-driven-DC-supply unit according to the fifth embodiment.

FIG. 14 is a side view of the engine-driven-DC-supply unit according to the fifth embodiment.

FIG. 15 is a front view of the engine-driven-DC-supply unit according to the fifth embodiment.

FIGS. 16A and 16B are views each schematically illustrating an example of a configuration of an engine-driven-DC-supply unit according to another embodiment.

FIGS. 17A and 17B are views each schematically illustrating an example of a configuration of an engine-driven-DC-supply unit according to another embodiment.

### DESCRIPTION OF EMBODIMENT

Embodiments of the present teaching will be described hereinafter with reference to the drawings. Dimensions of components in the drawings do not strictly represent actual dimensions of the components and dimensional proportions of the components, for example.

### First Embodiment

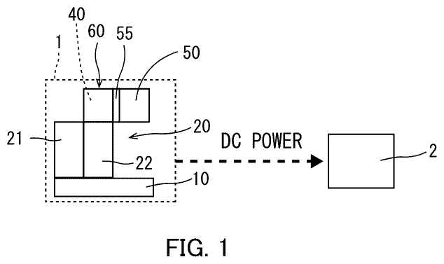

FIG. 1 is a side view schematically illustrating an example of an engine-driven-DC-supply unit 1 according to a first embodiment of the present teaching. The engine-driven-DC-supply unit 1 converts electric power generated by an electric generator 22 driven by an engine 21 to DC power by an electric power converter 30, and outputs the converted DC power. The engine-driven-DC-supply unit 1 supplies DC power to an external load device 2.

The engine-driven-DC-supply unit 1 is a unit without providing mechanical traveling power to the external load device 2. The external load device 2 includes, for example, an electric power storage or an electrical load. The external load device 2 is a device including, for example, the electric power storage or the electrical load and may be a mobile object or an immovable fixed device. Examples of the electric power storage include a battery and a capacitor. Examples of the electrical load include a motor, an illumination device, and electric equipment. The engine-driven-DC-supply unit 1 supplies DC power to the electric power storage or the electrical load included in the external load device 2.

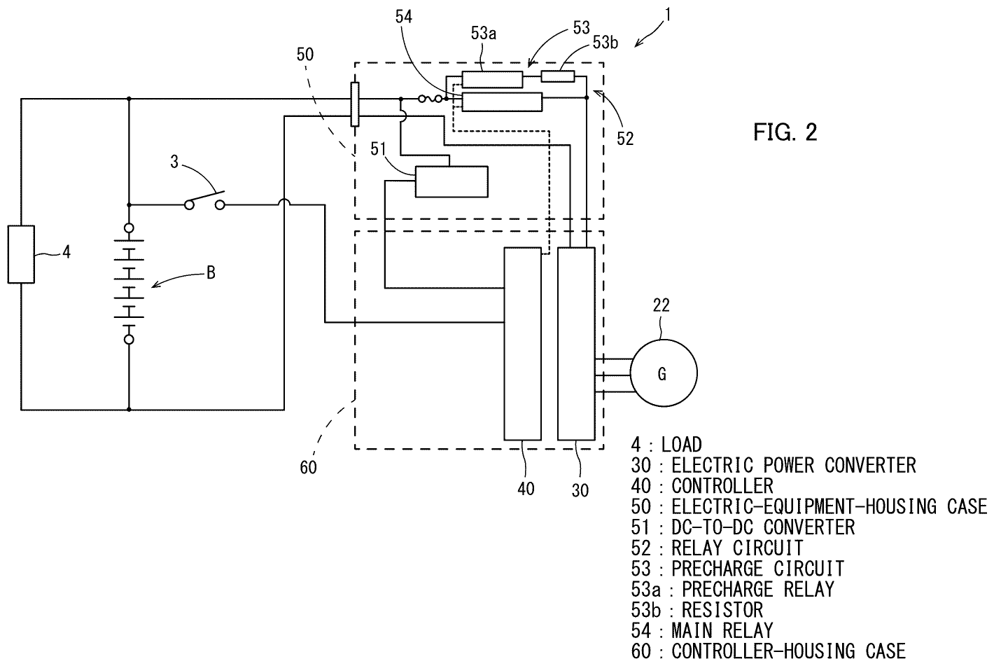

As illustrated in FIG. 1, the engine-driven-DC-supply unit 1 includes a base member 10, an engine electric generator 20, an electric-equipment-housing case 50, and a controller-housing case 60 housing an electric power converter 30 and a controller 40 (see FIG. 2).

The base member 10 may be, for example, a rectangular parallelepiped frame or may have a columnar structure or a plate-like structure. The base member 10 may have any shape and any structure as long as the base member 10 can directly or indirectly support the engine electric generator 20, the electric power converter 30, and the controller 40. In description of this embodiment, the base member 10 has a plate shape for simplicity of description, but the shape and the structure of the base member 10 are not limited to this embodiment.

The engine electric generator 20 includes the engine 21 and the electric generator 22. Although not shown, the engine 21 includes a piston, a cylinder, and a crankshaft. The piston reciprocates in the cylinder so that the crankshaft thereby rotates about an axis. Description of a specific configuration of the engine 21 will be omitted.

Although not shown, the electric generator 22 includes a rotor and a stator. The rotor is connected to a crankshaft of the engine 21. At start of the engine 21, the electric generator 22 imparts a starting force to the engine 21. At driving of the engine 21, the electric generator 22 generates electric power by a driving force of the engine 21. That is, the electric generator 22 has a function as a generator that is driven by the engine 21 and generates electric power and a function as a starter motor that imparts a driving force to the engine 21 by electric power of a battery at start of the engine 21. Description of a specific configuration of the electric generator 22 will be omitted. The electric generator 22 may have only the function as a generator. In this case, the engine-driven-DC-supply unit may include a starter motor as a separate member.

Electric power output from the electric generator 22 at driving of the engine is converted to DC power by the electric power converter 30. The converted DC power is output to the external load device 2 (battery B in an example described later and illustrated in FIG. 2). The external load device 2 is charged with the DC power. At start of the engine, the electric power converter 30 converts DC power supplied from the external load device 2 to alternating current (AC) power and outputs the AC power to the electric generator 22. In the electric generator 22 that has received the AC power, the rotor rotates.

When the rotor of the electric generator 22 rotates, the crankshaft of the engine 21 also rotates. This enables start of the engine 21 by cranking. At start of the engine 21, an ignition plug that ignites an air-fuel mixture in a combustion chamber, a throttle motor that adjusts an opening degree of a throttle valve in an intake pipe, and an injector that generates an air-fuel mixture by injecting fuel are actuated.

The controller 40 controls driving of the engine-driven-DC-supply unit 1. That is, the controller 40 has both functions of an engine control function of controlling the engine 21 and an electric-power-conversion-controlling function of controlling the electric power converter 30. The controller 40 may have only one of the engine control function or the electric-power-conversion-controlling function.

Engine control performed by the engine control function is, for example, the engine control performed at start of the engine and driving of the engine as described above. The engine control includes control concerning driving of an engine auxiliary machine for driving the engine 21. Electric power conversion performed by the electric-power-conversion-controlling function is, for example, control of the electric power converter 30 performed at start of the engine and driving of the engine as described above. Detailed description of the engine control function and the electric-power-conversion-controlling function will be omitted.

The controller 40 is constituted by, for example, a microcomputer, and executes various control actions according to control programs stored in an unillustrated memory. The memory may be constituted by a storage device disposed in the controller 40 or may be constituted by an external storage medium connected to the controller 40.

In the configuration illustrated in FIG. 2 described later, the controller 40 receives a voltage of the battery B and is started by turning a switch 3 on. The controller 40 operates upon receiving the voltage of the battery B stepped down by a DC-to-DC converter 51 housed in the electric-equipment-housing case 50 described later. The controller 40 controls driving of the DC-to-DC converter 51 and a relay circuit 52 housed in the electric-equipment-housing case 50.

The controller-housing case 60 houses the electric power converter 30 and the controller 40 (see FIG. 2). The controller-housing case 60 may house only the controller 40. That is, the controller-housing case 60 houses at least the controller 40.

The electric-equipment-housing case 50 is configured as a case different from the controller-housing case 60, and houses electric equipment electrically connected to the controller 40. The electric-equipment-housing case 50 is supported by an electric-equipment-housing-case supporter 55.

FIG. 2 is a functional block diagram illustrating an example of a schematic configuration of the engine-driven-DC-supply unit 1. The electric equipment is at least one of the relay circuit 52 including a precharge circuit 53, the DC-to-DC converter 51 that converts DC power to DC power at a different voltage, or external communication equipment 70 that communicates with external equipment other than the engine-driven-DC-supply unit 1 and a vehicle V by wireless connection or wired connection. In FIG. 2, a load 4 is electrically connected to the battery B. Examples of the load 4 include a motor.

The DC-to-DC converter 51 steps down a DC voltage of the battery B to a predetermined DC voltage and feeds the controller 40. That is, the DC-to-DC converter 51 is electrically connected to the controller 40 and converts DC power to DC power at a different voltage. The predetermined DC voltage is a driving voltage (e.g., 12 V) of the controller 40. The DC-to-DC converter 51 includes a plurality of switching devices, for example, and steps down a DC voltage by switching operation of the switching devices and outputs the DC voltage. Description of a specific configuration of the DC-to-DC converter 51 will be omitted.

The relay circuit 52 includes the precharge circuit 53 and a main relay 54.

The precharge circuit 53 includes a precharge relay 53a and a resistor 53b. The precharge relay 53a and the resistor 53b are electrically connected in series. The precharge circuit 53 is electrically connected in parallel to the main relay 54.

While the main relay 54 is in open, the precharge relay 53a is closed and enables power supply from the battery B to the electric power converter 30. Accordingly, it is possible to charge an unillustrated capacitor and other elements of the electric power converter 30 before the main relay 54 is closed. That is, the precharge circuit 53 can perform precharge of the capacitor and other elements of the electric power converter 30 before the main relay 54 is closed. In this manner, it is possible to prevent a flow of a large inrush current to the electric power converter 30 when the main relay 54 is closed. Examples of the precharge relay 53a include an electromagnetic switch and an electromagnetic contactor. Driving of the precharge relay 53a is controlled by the controller 40.

The resistor 53b is a resistor for adjusting a voltage in the precharge circuit 53. The precharge circuit 53 may be without the resistor 53b.

The main relay 54 is a relay that electrically connects and disconnects the battery B to/from the electric power converter 30. Examples of the main relay 54 include an electromagnetic switch and an electromagnetic contactor. Driving of the main relay 54 is controlled by the controller 40.

As illustrated in FIG. 2, the electric power converter 30 and the controller 40 are housed in the controller-housing case 60 including a casing different from the electric-equipment-housing case 50. The casing of the controller-housing case 60 is, for example, rectangular parallelepiped. A component housed in the controller-housing case 60 is electrically connected to a component housed in the electric-equipment-housing case 50. The controller-housing case 60 may be supported by the engine electric generator 20 or may be supported by the base member 10. The electric-equipment-housing case 50 may be supported by the engine electric generator 20, may be supported by the controller-housing case 60, or may be supported by the base member 10. The electric-equipment-housing case 50 is supported by the electric-equipment-housing-case supporter 55 described later.

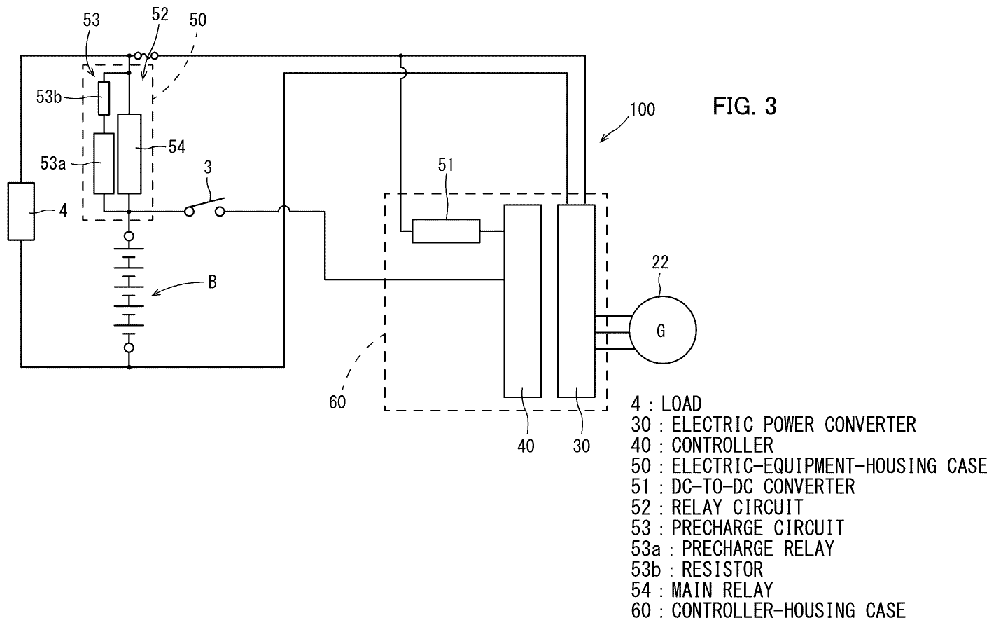

The engine-driven-DC-supply unit may be without the electric-equipment-housing case 50. That is, as illustrated in FIG. 3, the electric-equipment-housing case 50 may be located outside the engine-driven-DC-supply unit 100. Since the electric-equipment-housing case 50 is located outside the engine-driven-DC-supply unit 100 in this manner, the relay circuit 52 in the electric-equipment-housing case 50 is also located outside the engine-driven-DC-supply unit 100. This engine-driven-DC-supply unit without the electric-equipment-housing case 50 can also supply DC power to the external load device 2. Accordingly, versatility of the engine-driven-DC-supply unit can be enhanced.

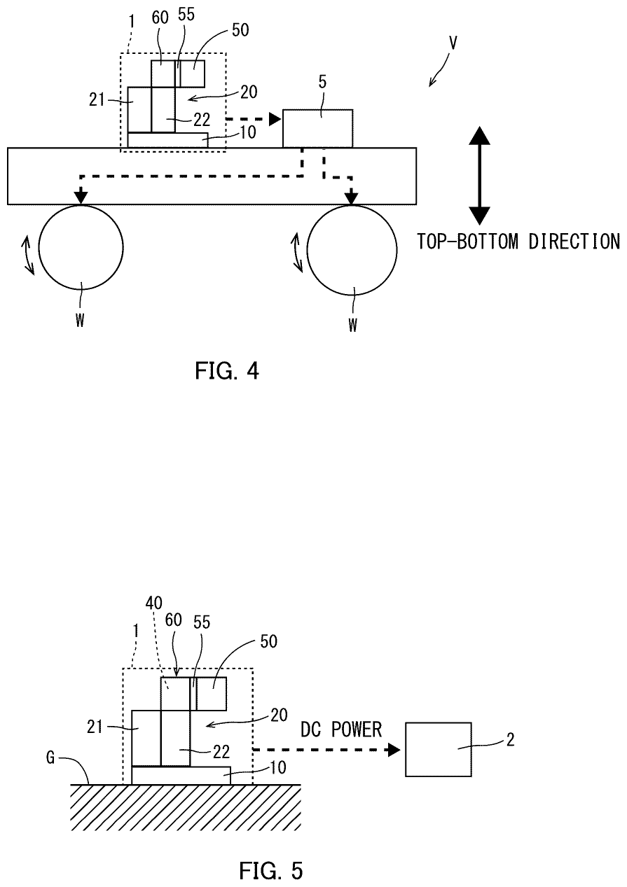

FIG. 4 is a side view schematically illustrating a case where the engine-driven-DC-supply unit 1 is mounted on a mobile object (vehicle V) that is an example of the external load device. FIG. 5 is a side view schematically illustrating a state where the engine-driven-DC-supply unit 1 placed on the ground G supplies electric power to the external load device 2 (e.g., battery). As illustrated in FIGS. 4 and 5, the engine-driven-DC-supply unit 1 may be mounted on the mobile object or may be placed on the ground G. The engine-driven-DC-supply unit 1 may be attached to the mobile body or a fixed device or may be placed on the ground G, a base, another device, or the like without being attached to another device, as long as the engine-driven-DC-supply unit 1 can supply DC power to the external load device 2.

The engine-driven-DC-supply unit 1 may charge the battery of the mobile object, for example. The battery of the mobile object may be attachable and detachable to/from the mobile object or may be fixed to the mobile object. The engine-driven-DC-supply unit 1 may charge a battery of an electric tool, an electric work machine, or the like, for example. The engine-driven-DC-supply unit 1 may supply electric power to an illumination device or other devices, for example. The engine-driven-DC-supply unit 1 may supply electric power to a driving source such as a motor of a pump or a motor of a compressor, for example.

The mobile object refers to an object that is movable by power, such as a vehicle, an aircraft, or a ship. The mobile object includes vehicles. The mobile object includes a power unit (e.g., motor) that generates power by energy supplied from an energy source. Examples of the energy source include the engine-driven-DC-supply unit 1 according to this embodiment and a battery.

A configuration of the engine-driven-DC-supply unit 1 mountable or detachable to/from a mobile object that is an example of the external load device 2 will be described below.

The engine-driven-DC-supply unit 1 is mountable or detachable to/from the mobile object. The engine-driven-DC-supply unit 1 is a unit without providing mechanical traveling power to the mobile object. Although a parallel hybrid engine unit that provides mechanical traveling power to a mobile object needs a structure for mechanically transferring a driving force to wheels, in the engine-driven-DC-supply unit 1 without providing mechanical traveling power to the mobile object as described above, a structure for mechanically transferring a driving force to wheels is unnecessary. Thus, the engine-driven-DC-supply unit 1 has excellent attachability and detachability for the mobile object.

In the example shown in FIG. 4, the mobile object is a vehicle V. DC power output from the engine-driven-DC-supply unit 1 is supplied to an unillustrated motor for driving wheels W of the vehicle V through an electric-power controller 5 in the vehicle V, as indicated by broken arrows. The electric-power controller 5 is mounted on the vehicle V as the mobile object and controls driving of the motor. Thus, the electric-power controller 5 is unsupported by the base member 10 of the engine-driven-DC-supply unit. The electric-power controller 5 corresponds to an external-load-device controller that controls a motor as electric equipment mounted on the vehicle V as the external load device 2. The engine-driven-DC-supply unit 1 may supply DC power to an unillustrated battery mounted on the vehicle V. The engine-driven-DC-supply unit 1 supplies DC power to at least one of the motor or the battery.

In the example shown in FIG. 4, front wheels and rear wheels of the vehicle V are driven by the motor using DC power output from the engine-driven-DC-supply unit 1, but only the front wheels or the rear wheels may be driven. The vehicle V may include a battery to charge the battery with DC power output from the engine-driven-DC-supply unit 1 and drive wheels W by the motor using electric power of the battery. A load connected to the battery includes the motor for driving the wheels W. In a case where the engine-driven-DC-supply unit 1 is mounted on the vehicle V, the battery is disposed in the vehicle V. In a case where the engine-driven-DC-supply unit 1 is unmounted on the vehicle V, the battery is disposed outside the engine-driven-DC-supply unit 1. That is, the battery is located outside the engine-driven-DC-supply unit 1.

The base member 10 is fixed to the vehicle V. The engine electric generator 20, the electric-equipment-housing case 50, and the controller-housing case 60 are supported by the base member 10. the electric-power controller 5, which controls the motor mounted on the vehicle V, is unsupported by the base member 10. The method for fixing the base member 10 to the vehicle V may be any method such as fastening with bolts, fitting, bonding, or welding. The base member 10 may be mountably and detachably attached to the vehicle V. That is, the engine-driven-DC-supply unit 1 is mountable or detachable to/from the vehicle V with the base member 10.

The engine-driven-DC-supply unit without electric-equipment-housing case 50 is also mountable or detachable to/from the vehicle V. That is, the engine-driven-DC-supply unit is mountable or detachable to/from the vehicle V irrespectively of the presence of the electric-equipment-housing case 50.

In the manner described above, the engine-driven-DC-supply unit 1 according to this embodiment is a unit including: the electric generator 22; the engine 21 that drives the electric generator 22; the electric power converter 30 that converts electric power generated by the electric generator 22 driven by the engine 21 to DC power and outputs the converted DC power to the external load device 2 located outside the engine-driven-DC-supply unit 1; the controller 40 that controls at least one of the electric power converter 30 or the engine 21; the controller-housing case 60 that houses at least the controller 40; and the base member 10 that directly or indirectly supports the electric generator 22, the engine 21, the electric power converter, and the controller 40.

The engine-driven-DC-supply unit 1 includes the electric-equipment-housing-case supporter 55 supporting the electric-equipment-housing case 50 that is configured as a case different from the controller-housing case 60 and houses electric equipment electrically connected to the controller 40.

The electric-equipment-housing-case supporter 55 is disposed in at least one of the electric generator 22, the engine 21, the controller-housing case 60, or the base member 10 such that the electric-equipment-housing case 50 housing at least one of the relay circuit 52, the DC-to-DC converter 51, or the external communication equipment 70 while avoiding an overlap of the relay circuit 52, the DC-to-DC converter 51, and the external communication equipment 70 depending on whether the relay circuit 52, the DC-to-DC converter 51, and the external communication equipment 70 are mounted on the external load device 2 is supported at a position at which the electric-equipment-housing case 50 is free of contact with the external load device 2, in a case where the engine-driven-DC-supply unit 1 is electrically connected to the external load device 2.

Accordingly, the electric-equipment-housing-case supporter 55 disposed in at least one of the electric generator 22, the engine 21, the controller-housing case 60, or the base member 10 can support the electric-equipment-housing case 50 housing at least one of the relay circuit 52, the DC-to-DC converter 51, or the external communication equipment 70 while avoiding an overlap of the relay circuit 52, the DC-to-DC converter 51, and the external communication equipment 70 depending on whether the relay circuit 52, the DC-to-DC converter 51, and the external communication equipment 70 are mounted on the external load device 2, at a position at which the electric-equipment-housing case 50 is free of contact with the external load device 2, in the case where the engine-driven-DC-supply unit 1 is electrically connected to the external load device 2. That is, the electric-equipment-housing case 50 houses at least one of the relay circuit 52, the DC-to-DC converter 51, or the external communication equipment 70 to avoid an overlap with electric equipment disposed in the external load device 2 in a case where the engine-driven-DC-supply unit 1 is electrically connected to the external load device 2. The electric-equipment-housing-case supporter 55 may not support the electric-equipment-housing case 50 to avoid an overlap with the electric equipment disposed in the external load device 2, that is, the engine-driven-DC-supply unit 1 may be without the electric-equipment-housing case 50.

Accordingly, the configuration of the engine-driven-DC-supply unit 1 can be easily changed depending on the type, required specifications, and other characteristics of the external load device 2. As a result, versatility of the engine-driven-DC-supply unit 1 can be enhanced to enable supply of DC power to various types of external load devices.

In this embodiment, the engine-driven-DC-supply unit 1 supplies DC power to an electric power storage or an electrical load included in the external load device 2. Accordingly, DC power is supplied by the engine-driven-DC-supply unit 1 to the electric power storage or the electrical load included in the external load device 2. In this manner, the engine-driven-DC-supply unit 1 can supply DC power to various types of the external load devices 2. As a result, highly versatile engine-driven-DC-supply unit 1 can be obtained.

### Second Embodiment

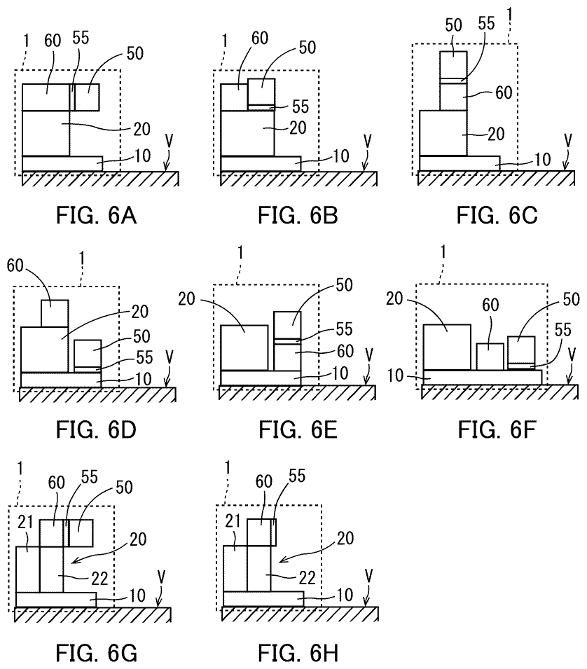

In this embodiment, an example of layout of the engine-driven-DC-supply unit 1 will be described. FIGS. 6A through 6H are views each illustrating an example of layout of the engine-driven-DC-supply unit 1. In the following description, the top-bottom direction refers to the top-bottom direction of the engine-driven-DC-supply unit 1 in a state where the engine-driven-DC-supply unit 1 is mounted on the external load device 2 such as the vehicle V or placed on the ground G or the like.

As illustrated in FIG. 6A, the base member 10 of the engine-driven-DC-supply unit 1 is fixed to the external load device 2 such as the vehicle V or placed on the ground G or the like. FIG. 6 schematically illustrates a case where the base member 10 is fixed to the vehicle V, as an example.

The base member 10 supports the engine electric generator 20, the electric-equipment-housing case 50, and the controller-housing case 60. The engine electric generator 20 is fixed to the top of the base member 10. The controller-housing case 60 is fixed to the top of the engine electric generator 20. The electric-equipment-housing case 50 is supported by the controller-housing case 60 through the electric-equipment-housing-case supporter 55. In this manner, in the example illustrated in FIG. 6A, the electric-equipment-housing-case supporter 55 is attached to the controller-housing case 60. In the example illustrated in FIG. 6A, the controller-housing case 60 is supported by the engine electric generator 20, and the electric-equipment-housing case 50 is supported by the controller-housing case 60.

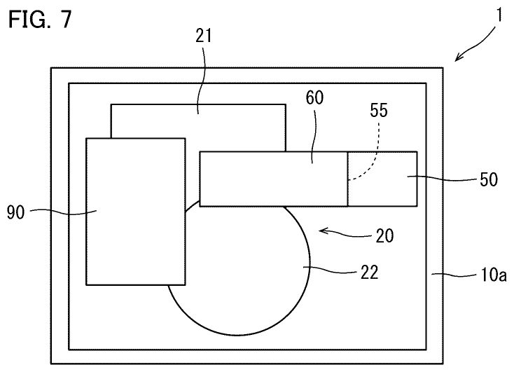

FIG. 7 illustrates a specific layout example of the engine-driven-DC-supply unit 1 illustrated in FIG. 6A. In the example illustrated in FIG. 7, the electric-equipment-housing-case supporter 55 is a portion where the electric-equipment-housing case 50 is connected to the controller-housing case 60 (e.g., mounting bolt, bolt insertion hole, fixing base, engagement portion, etc.). In FIG. 7, reference sign 90 denotes a muffler connected to an exhaust pipe of the engine 21, and reference sign 10a denotes a support frame constituting a base member.

Although not particularly shown in FIG. 7, the engine electric generator 20 is supported by a support frame 10a.

Although not particularly shown, the electric-equipment-housing-case supporter 55 attached to the controller-housing case 60 includes an electric-equipment-housing-case-connection portion for connection to the electric-equipment-housing case 50, and a controller-housing-case-connection portion for connection to the controller-housing case 60. The electric-equipment-housing-case supporter 55 may house a bus bar, a wire, or the like for electrically connecting a component housed in the electric-equipment-housing case 50 to a component housed in the controller-housing case 60.

As illustrated in FIGS. 6B and 6C, the electric-equipment-housing case 50 and the controller-housing case 60 may be disposed on the engine electric generator 20. The electric-equipment-housing case 50 and the controller-housing case 60 may be disposed side by side on the engine electric generator 20 as illustrated in FIG. 6B. As illustrated in FIG. 6C, the electric-equipment-housing case 50 may be disposed above the controller-housing case 60 on the engine electric generator 20, with the electric-equipment-housing-case supporter 55 interposed between the electric-equipment-housing case 50 and the controller-housing case 60.

Although not particularly shown, the electric-equipment-housing-case supporter 55 to be attached to the engine electric generator 20 includes an electric-equipment-housing-case-connection portion for connection to the electric-equipment-housing case 50, and an engine-electric-generator-connection portion for connection to the engine electric generator 20.

As illustrated in FIG. 6D, the electric-equipment-housing case 50 may be unsupported by the controller-housing case 60. In the example illustrated in FIG. 6D, the controller-housing case 60 is supported by the engine electric generator 20, and the electric-equipment-housing case 50 is supported by the base member 10 through the electric-equipment-housing-case supporter 55. In this manner, the electric-equipment-housing-case supporter 55 may be attached to the base member 10. The controller-housing case 60 may be attached to the top or a side of the engine electric generator 20.

Although not particularly shown, the electric-equipment-housing-case supporter 55 to be attached to the base member 10 includes an electric-equipment-housing-case-connection portion for connection to the electric-equipment-housing case 50, and a base-member-connection portion for connection to the base member 10.

In FIG. 6D, the electric-equipment-housing case 50 may be supported by the engine electric generator 20, and the controller-housing case 60 may be supported by the base member 10.

As illustrated in FIG. 6E, the electric-equipment-housing case 50 and the controller-housing case 60 may be unsupported by the engine electric generator 20. In the example illustrated in FIG. 6E, the controller-housing case 60 is supported by the base member 10. The electric-equipment-housing case 50 is supported by the controller-housing case 60 through the electric-equipment-housing-case supporter 55. That is, in the example illustrated in FIG. 6E, the electric-equipment-housing-case supporter 55 is attached to the controller-housing case 60. The electric-equipment-housing case 50 may be located above the controller-housing case 60 or at a side of the controller-housing case 60.

As illustrated in FIG. 6F, the electric-equipment-housing case 50 and the controller-housing case 60 may be separately disposed on the base member 10. The electric-equipment-housing case 50 is supported by the base member 10 through the electric-equipment-housing-case supporter 55.

As illustrated in FIG. 6G, the controller-housing case 60 may be disposed on the electric generator 22, and the electric-equipment-housing case 50 may be supported by the controller-housing case 60 through the electric-equipment-housing-case supporter 55. In this case, the electric-equipment-housing-case supporter 55 is also attached to the controller-housing case 60.

As illustrated in FIG. 6H, the controller-housing case 60 may be disposed on the electric generator 22 and the electric-equipment-housing case 50 may be unmounted to the controller-housing case 60. The controller-housing case 60 is provided with the electric-equipment-housing-case supporter 55. The electric-equipment-housing case 50 may be attachable and detachable to/from the controller-housing case 60 by the electric-equipment-housing-case supporter 55. Although not particularly shown, in the configurations of FIGS. 6A through 6G, the electric-equipment-housing case 50 may be unprovided in the engine-driven-DC-supply unit. In this case, the electric-equipment-housing-case supporter 55 is still provided in the engine-driven-DC-supply unit 1.

As described above, in the engine-driven-DC-supply unit 1, the electric-equipment-housing case 50 may be supported by the controller-housing case 60, may be supported by the base member 10, or may be supported by the engine electric generator 20. In any case, the electric-equipment-housing case 50 is supported to a component of the engine-driven-DC-supply unit 1 through the electric-equipment-housing-case supporter 55. Such a support state of the electric-equipment-housing case 50 is an electric-equipment-housing-case-support state.

The electric-equipment-housing-case supporter 55 is disposed in at least one of the electric generator 22, the engine 21, the controller-housing case 60, or the base member 10.

Specifically, the electric-equipment-housing-case supporter 55 is disposed in at least one of the electric generator 22, the engine 21, the controller-housing case 60, or the base member 10 such that the electric-equipment-housing case 50 housing at least one of the relay circuit 52, the DC-to-DC converter 51, or the external communication equipment 70 described later while avoiding an overlap of the relay circuit 52, the DC-to-DC converter 51, and the external communication equipment 70 depending on whether the relay circuit 52, the DC-to-DC converter 51, and the external communication equipment 70 are mounted on the external load device 2 is supported at a position at which the electric-equipment-housing case 50 is free of contact with the external load device 2.

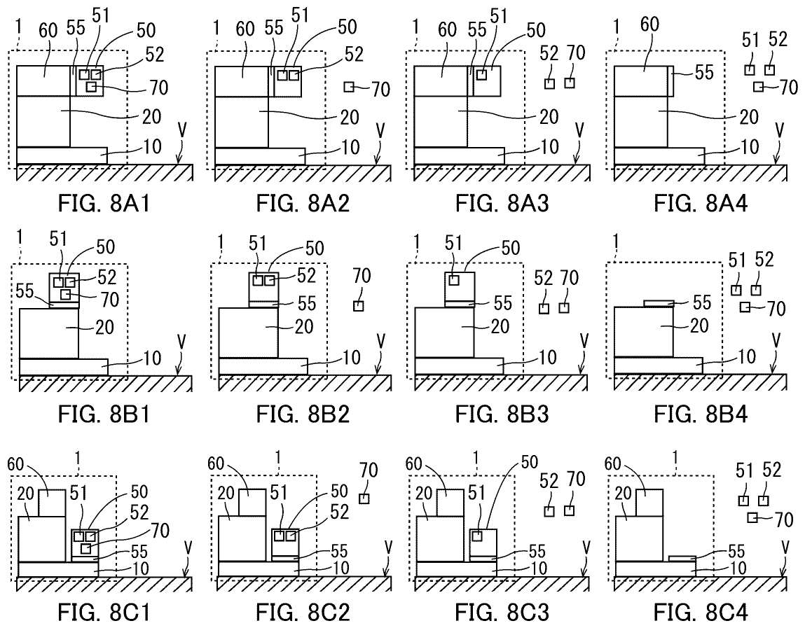

FIG. 8 shows views in each of which in the engine-driven-DC-supply unit 1 and the external load device 2 (vehicle V as an example of the external load device 2 in FIG. 8), the relay circuit 52, the DC-to-DC converter 51, and the external communication equipment 70 are provided to avoid an overlap depending on whether the relay circuit 52, the DC-to-DC converter 51, and the external communication equipment 70 are mounted on the external load device 2.

FIGS. 8A1 through 8A4 are views each illustrating a state where in the case where the electric-equipment-housing-case supporter 55 is provided in the controller-housing case 60, the relay circuit 52, the DC-to-DC converter 51, and the external communication equipment 70 are disposed in the external load device 2 (vehicle V as an example of the external load device 2) and the engine-driven-DC-supply unit 1 to avoid an overlap. FIGS. 8B1 through 8B4 are views each illustrating a state where in the case where the electric-equipment-housing-case supporter 55 is provided in the engine electric generator 20, the relay circuit 52, the DC-to-DC converter 51, and the external communication equipment 70 are disposed in the external load device 2 (vehicle V as an example of the external load device 2) and the engine-driven-DC-supply unit 1 to avoid an overlap. FIGS. 8C1 through C4 are views each illustrating a state where in the case where the electric-equipment-housing-case supporter 55 is provided in the base member 10, the relay circuit 52, the DC-to-DC converter 51, and the external communication equipment 70 are disposed in the external load device 2 (vehicle V as an example of the external load device 2) and the engine-driven-DC-supply unit 1 to avoid an overlap.

FIGS. 8A1, 8B1, and 8C1 are views each illustrating a state where the relay circuit 52, the DC-to-DC converter 51, and the external communication equipment 70 are unprovided in the vehicle V as an example of the external load device 2 and the relay circuit 52, the DC-to-DC converter 51, and the external communication equipment 70 are housed in the electric-equipment-housing case 50 of the engine-driven-DC-supply unit 1. FIGS. 8A2, 8B2, and 8C2 are views each illustrating a state where the external communication equipment 70 is provided in the vehicle V as an example of the external load device 2, and the relay circuit 52 and the DC-to-DC converter 51 are housed in the electric-equipment-housing case 50 of the engine-driven-DC-supply unit 1. The relay circuit 52 may be provided in the vehicle V as an example of the external load device 2, and the DC-to-DC converter 51 and the external communication equipment 70 may be housed in the electric-equipment-housing case 50. The DC-to-DC converter 51 may be provided in the vehicle V as an example of the external load device 2, and the relay circuit 52 and the external communication equipment 70 may be housed in the electric-equipment-housing case 50.

FIGS. 8A3, 8B3, and 8C3 are views each illustrating a state where the relay circuit 52 and the external communication equipment 70 are provided in the vehicle V as an example of the external load device 2, and the DC-to-DC converter 51 is housed in the electric-equipment-housing case 50 of the engine-driven-DC-supply unit 1. The relay circuit 52 and the DC-to-DC converter 51 may be provided in the vehicle V, and the external communication equipment 70 may be housed in the electric-equipment-housing case 50. The DC-to-DC converter 51 and the external communication equipment 70 may be provided in the vehicle V as an example of the external load device 2, and the relay circuit 52 may be housed in the electric-equipment-housing case 50.

FIGS. 8A4, 8B4, and 8C4 are views each illustrating a state where the relay circuit 52, the DC-to-DC converter 51, and the external communication equipment 70 are provided in the vehicle V as an example of the external load device 2, and the engine-driven-DC-supply unit 1 is without the electric-equipment-housing case 50.

The electric-equipment-housing-case supporter 55 may be disposed in at least one of the electric generator 22, the engine 21, the controller-housing case 60, or the base member 10 to support the electric-equipment-housing case 50 at a position that is without hindering attachment and detachment of the base member 10 to/from the external load device 2.

The electric-equipment-housing-case supporter 55 includes a structure of a connection portion provided in at least one of the electric-equipment-housing case 50 or a member to which the electric-equipment-housing case 50 is attached. Examples of the electric-equipment-housing-case supporter 55 include an attachment hole, an attachment base, a coupling member (bolt, bis, stud, hook, etc.), an attachment member such as an attachment, and an uneven portion for engagement. The electric-equipment-housing-case supporter 55 may be a member different from a member to which the electric-equipment-housing case 50 is attached, or may be integrated with the member to which the electric-equipment-housing case 50 is attached.

The engine-driven-DC-supply unit may include the electric-equipment-housing case 50, or may be without the electric-equipment-housing case 50. In this case, the electric-equipment-housing case 50 is unsupported by the electric-equipment-housing-case supporter 55. Thus, this state is an electric-equipment-housing-case-unsupport state.

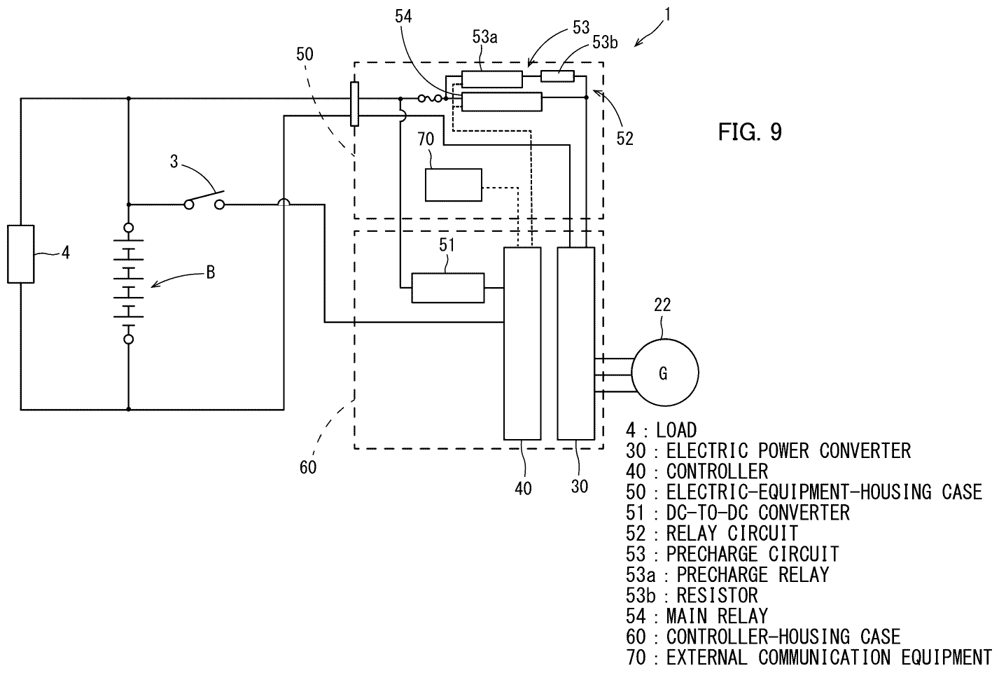

In this embodiment, the electric-equipment-housing case 50 of the engine-driven-DC-supply unit 1 houses the DC-to-DC converter 51 and the relay circuit 52. Alternatively, as illustrated in FIG. 9, the electric-equipment-housing case 50 may house the relay circuit 52 without the DC-to-DC converter 51. Although not particularly shown, the electric-equipment-housing case 50 may house the DC-to-DC converter 51 without the relay circuit 52.

As illustrated in FIG. 9, the electric-equipment-housing case 50 may house the external communication equipment 70 for wireless communication or wired communication to external equipment. The external communication equipment 70 is electrically connected to the controller 40 so that driving of the external communication equipment 70 is controlled by the controller 40. Data to be transmitted from the external communication equipment 70 to the external equipment is output from the controller 40, and data received by the external communication equipment 70 from the external equipment is transmitted to the controller 40. Accordingly, the engine-driven-DC-supply unit 1 can communicate with external equipment such as a user's terminal with the external communication equipment 70. The external communication equipment 70 is included in electric equipment housed in the electric-equipment-housing case 50.

In the case where the electric-equipment-housing case 50 houses the external communication equipment 70, the electric-equipment-housing case 50 may house the DC-to-DC converter 51 or may be without housing the DC-to-DC converter 51. In the case where the electric-equipment-housing case 50 houses the external communication equipment 70, the electric-equipment-housing case 50 may house the relay circuit 52 or may be without housing the relay circuit 52.

As described above, the electric-equipment-housing case 50 according to this embodiment houses at least one of the DC-to-DC converter 51, the relay circuit 52, or the external communication equipment 70. The electric-equipment-housing case 50 houses at least one of the relay circuit 52, the DC-to-DC converter 51, or the external communication equipment 70 to avoid an overlap of the relay circuit 52, the DC-to-DC converter 51, and the external communication equipment 70 depending on whether the relay circuit 52, the DC-to-DC converter 51, and the external communication equipment 70 are mounted on the external load device 2.

In this embodiment, the engine-driven-DC-supply unit 1 is a unit including: the electric generator 22; the engine 21 that drives the electric generator 22; the electric power converter 30 that converts electric power generated by the electric generator 22 driven by the engine 21 to DC power and outputs the converted DC power to the external load device 2; the controller 40 that controls at least one of the electric power converter 30 or the engine 21; the controller-housing case 60 housing at least the controller 40; and the base member 10 that directly or indirectly supports the electric generator 22, the engine 21, the electric power converter 30, and the controller 40, and supplies the DC power without providing mechanical power for driving to the external load device 2.

The engine-driven-DC-supply unit 1 includes the electric-equipment-housing-case supporter 55 supporting the electric-equipment-housing case 50 that is configured as a case different from the controller-housing case 60 and houses electric equipment electrically connected to the controller 40.

The electric equipment is at least one of the relay circuit 52 including the precharge circuit 53, the DC-to-DC converter 51 that converts the DC power to DC power at a different voltage, or the external communication equipment 70 that communicates with external equipment other than the engine-driven-DC-supply unit 1 and the external load device 2 by wireless connection or wired connection. The base member 10 may be configured such that the engine-driven-DC-supply unit 1 is mountable or detachable to/from the external load device 2.

The electric-equipment-housing-case supporter 55 is disposed in at least one of the electric generator 22, the engine 21, the controller-housing case 60, or the base member 10 such that the electric-equipment-housing case 50 housing at least one of the relay circuit 52, the DC-to-DC converter 51, or the external communication equipment 70 while avoiding an overlap of the relay circuit 52, the DC-to-DC converter 51, and the external communication equipment 70 depending on whether the relay circuit 52, the DC-to-DC converter 51, and the external communication equipment 70 are mounted on the external load device 2 is supported at a position at which the electric-equipment-housing case 50 is free of contact with the external load device 2.

Accordingly, the electric-equipment-housing-case supporter 55 disposed in at least one of the electric generator 22, the engine 21, the controller-housing case 60, or the base member 10 can support the electric-equipment-housing case 50 housing at least one of the relay circuit 52, the DC-to-DC converter 51, or the external communication equipment 70 while avoiding an overlap of the relay circuit 52, the DC-to-DC converter 51, and the external communication equipment 70 depending on whether the relay circuit 52, the DC-to-DC converter 51, and the external communication equipment 70 are mounted on the external load device 2, at a position at which the electric-equipment-housing case 50 is free of contact with the external load device 2. That is, the electric-equipment-housing case 50 houses at least one of the relay circuit 52, the DC-to-DC converter 51, or the external communication equipment 70 to avoid an overlap with electric equipment disposed in the external load device 2. The electric-equipment-housing-case supporter 55 may not support the electric-equipment-housing case 50 to avoid an overlap with the electric equipment disposed in the external load device 2. That is, the engine-driven-DC-supply unit 1 may be without the electric-equipment-housing case 50.

Accordingly, the configuration of the engine-driven-DC-supply unit 1 can be easily changed depending on the type, required specifications, and other characteristics of the external load device 2. As a result, versatility of the engine-driven-DC-supply unit 1 can be enhanced to enable supply of DC power to various types of external load devices 2.

In the case where the external load device 2 is a mobile object such as the vehicle V, advantages can be obtained as follows. In the engine-driven-DC-supply unit 1 without providing mechanical power for movement to a mobile object such as the vehicle V, it is unnecessary to transfer mechanical power between the unit 1 and the mobile object, unlike a parallel hybrid engine unit that provides mechanical traveling power to a mobile object. Thus, in the engine-driven-DC-supply unit 1, a structure for mechanically transferring a driving force to wheels is unnecessary. Accordingly, the engine-driven-DC-supply unit 1 has excellent attachability and detachability for the mobile object, and high mountability to the mobile object.

Since the engine-driven-DC-supply unit 1 having excellent attachability and detachability for the mobile object and high mountability to the mobile object as described above is configured to avoid an overlap of electric equipment depending on whether the electric equipment is mounted on the mobile object, mountability of the engine-driven-DC-supply unit 1 to various types of mobile objects can be enhanced.

Thus, it is possible to obtain the engine-driven-DC-supply unit 1 with enhanced mountability to various types of mobile objects.

In addition, in this embodiment, the electric-equipment-housing-case supporter 55 is disposed in at least one of the electric generator 22, the engine 21, the controller-housing case 60, or the base member 10 to support the electric-equipment-housing case 50 at a position that is without hindering attachment and detachment of the base member 10 to/from the external load device 2.

Accordingly, the electric-equipment-housing-case supporter 55 supports the electric-equipment-housing case 50 without hindering attachment and detachment of the base member 10 to/from the external load device 2. Thus, it is possible to obtain the engine-driven-DC-supply unit 1 with enhanced mountability to various types of external load devices 2.

Further, in this embodiment, it is preferable that the battery (electric power storage) is unprovided in the engine-driven-DC-supply unit 1. That is, the engine-driven-DC-supply unit 1 supplies electric power to the battery that is directly or indirectly unsupported by the base member 10 and supported by the external load device 2. Since the battery is directly or indirectly unsupported by the base member 10 of the engine-driven-DC-supply unit 1 as described above, the configuration of the engine-driven-DC-supply unit 1 including the base member 10 can be made compact. The battery may be provided in the engine-driven-DC-supply unit 1. The engine-driven-DC-supply unit 1 may supply electric power to an electrical load that is directly or indirectly unsupported by the base member 10 and supported by the external load device 2.

Furthermore, in this embodiment, the electric-power controller 5 for controlling electric equipment mounted on the external load device 2 is unsupported by the base member 10. Thus, the size of the engine-driven-DC-supply unit 1 can be reduced.

### Third Embodiment

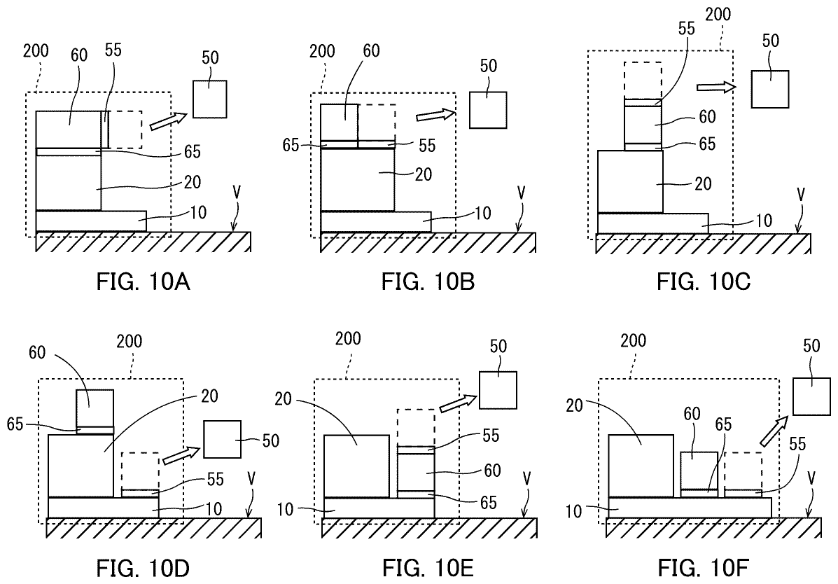

FIG. 10 shows views each schematically illustrating a configuration of an engine-driven-DC-supply unit 200 according to a third embodiment. A configuration of the third embodiment is different from that of the second embodiment in that a controller-housing case 60 is supported by a controller-housing-case supporter 65. In the following description, components similar to those of the second embodiment are denoted by the same reference signs and will not be described again, and only components different from those of the second embodiment will be described.

As illustrated in FIGS. 10A through 10F, the controller-housing case 60 is attached to an engine electric generator 20 or a base member 10 through the controller-housing-case supporter 65. That is, the controller-housing case 60 is supported to the engine electric generator 20 or the base member 10 by the controller-housing-case supporter 65. The controller-housing-case supporter 65 is disposed in at least one of an electric generator 22, an engine 21, or a base member 10 to support the controller-housing case 60 at a position at which the controller-housing case 60 is free of contact with an external load device 2 (vehicle V as an example of an external load device in FIG. 10).

Layouts of the engine-driven-DC-supply unit 200 illustrated in FIGS. 10A through 10F are the same as those illustrated in FIGS. 6A through 6F except that the controller-housing case 60 is supported by the controller-housing-case supporter 65. Thus, detailed description of FIGS. 10A through 10F will be omitted.

Although not particularly shown, the controller-housing-case supporter 65 to be attached to the engine electric generator 20 includes a controller-housing-case-connection portion for connection to the controller-housing case 60, and an engine-electric-generator-connection portion for connection to the engine electric generator 20. In this case, the controller-housing-case supporter 65 may house a bus bar, a wire, or the like for electrically connecting a component housed in the controller-housing case 60 to the electric generator 22.

Although not particularly shown, the controller-housing-case supporter 65 to be attached to the base member 10 includes a controller-housing-case-connection portion for connection to the controller-housing case 60, and a base-member-connection portion for connection to the base member 10.

The controller-housing-case supporter 65 includes a structure of a connection portion provided in at least one of the controller-housing case 60 or a member to which the controller-housing case 60 is attached. Examples of the controller-housing-case supporter 65 include an attachment hole, an attachment base, a coupling member (bolt, bis, stud, hook, etc.), an attachment member such as an attachment, and an uneven portion for engagement. The controller-housing-case supporter 65 may be a member different from the member to which the controller-housing case 60 is attached, or may be integrated with the member to which the controller-housing case 60 is attached.

As illustrated in FIGS. 10A through 10F, in a controller-housing-case-support state where the controller-housing case 60 is supported by the controller-housing-case supporter 65, the electric-equipment-housing-case supporter 55 is configured such that the electric-equipment-housing case 50 is mountable or detachable to/from the electric-equipment-housing-case supporter 55. The electric-equipment-housing-case supporter 55 is disposed in at least one of the electric generator 22, the engine 21, the controller-housing case 60, or the base member 10 to support the electric-equipment-housing case 50 at a position at which the electric-equipment-housing case 50 is attachable and detachable even in the state where the controller-housing-case supporter 65 supports the controller-housing case 60.

In the example illustrated in each of FIGS. 10A through 10F, the electric-equipment-housing case 50 is mountable or detachable to/from the electric-equipment-housing-case supporter 55. Alternatively, the electric-equipment-housing-case supporter 55 connected to the electric-equipment-housing case 50 may be mountable or detachable to/from the controller-housing case 60, the base member 10, or the engine electric generator 20.

Accordingly, in the controller-housing-case-support state where the controller-housing-case supporter 65 supports the controller-housing case 60, the electric-equipment-housing case 50 can be mounted or attached/detached to/from the electric-equipment-housing-case supporter 55. Accordingly, the configuration of the engine-driven-DC-supply unit 200 can be easily changed depending on the type, required specifications, and other characteristics of the external load device 2. As a result, versatility of the engine-driven-DC-supply unit 200 can be enhanced to enable supply of DC power to various types of external load devices 2. In a case where the engine-driven-DC-supply unit 200 is mounted on the external load device 2, mountability to various types of external load devices 2 can be enhanced.

### Fourth Embodiment

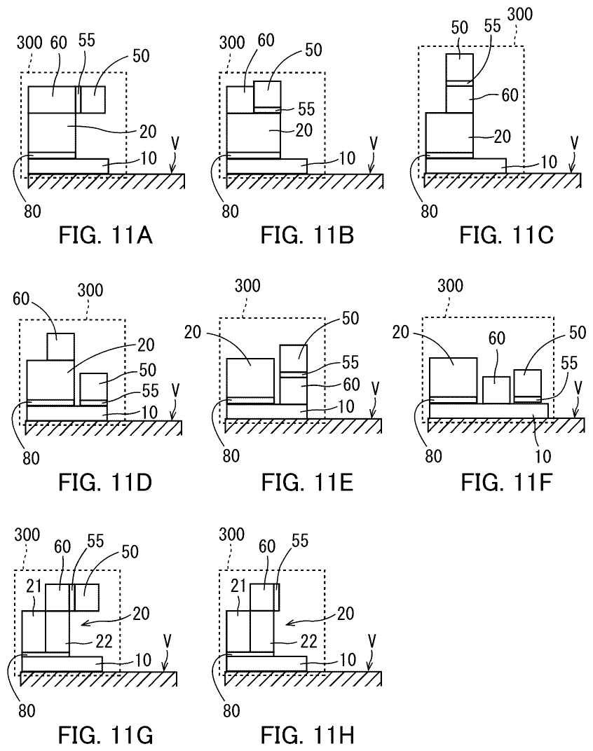

FIG. 11 shows views each illustrating an example of an engine-driven-DC-supply unit 300 according to a fourth embodiment. In this embodiment, an engine electric generator 20 is elastically supported by a base member 10 through an elastic member 80. In the following description, components similar to those of the second embodiment are denoted by the same reference signs and will not be described again, and only components different from those of the second embodiment will be described.

As illustrated in FIG. 11, the engine electric generator 20 is elastically supported by the base member 10 through the elastic member 80. Layout examples of the engine-driven-DC-supply unit 300 illustrated in FIGS. 11A through 11H are the same as those of the engine-driven-DC-supply unit 1 illustrated in FIGS. 6A through 6H. Thus, detailed description of the layout examples of the engine-driven-DC-supply unit 300 illustrated in FIGS. 11A through 11H will be omitted.

The elastic member 80 may be a rubber bush constituted by, for example, rubber, or may be an extensible member constituted by, for example, a spring. The elastic member 80 may be any member as long as the elastic member 80 can elastically support an engine electric generator 20 to the base member 10.

As described above, since the engine electric generator 20 is elastically supported to the base member 10 by the elastic member 80, it is possible to suppress transfer of vibrations generated in the engine electric generator 20 to a vehicle V as an example of an external load device 2 through the base member 10.

As illustrated in FIG. 11D, a controller-housing case 60 is supported by the engine electric generator 20, and an electric-equipment-housing case 50 is unsupported by the engine electric generator 20. Thus, the controller-housing case 60 is elastically supported to the base member 10 through the elastic member 80, and the electric-equipment-housing case 50 is supported to the base member 10 or the external load device 2 (vehicle V in the illustrated example) without use of the elastic member 80 as an intermediary. That is, the electric-equipment-housing case 50 is supported to the base member 10 by the electric-equipment-housing-case supporter 55 without the use of the elastic member 80 as an intermediary, and the controller-housing case 60 is supported to the based member 10 by an unillustrated controller-housing-case supporter through the elastic member 80.

In the example illustrated in FIG. 11D, the controller-housing case 60 is supported by the engine electric generator 20, and the electric-equipment-housing case 50 is supported by the base member 10. Alternatively, the electric-equipment-housing case may be supported by the engine electric generator, and the controller-housing case may be supported by the base member. That is, the electric-equipment-housing case may be elastically supported to the base member by the electric-equipment-housing-case supporter through the elastic member, and the controller-housing case may be supported to the base member by the controller-housing-case supporter without use of the elastic member as an intermediary.

With the foregoing configuration, since one of the electric-equipment-housing case 50 or the controller-housing case 60 is supported through the elastic member 80, in a case where a force, vibrations, or the like is input to the electric-equipment-housing case 50 and the controller-housing case 60, the electric-equipment-housing case 50 and the controller-housing case 60 exhibit different movements. That is, the electric-equipment-housing case 50 and the controller-housing case 60 are individually supported such that the electric-equipment-housing case 50 and the controller-housing case 60 exhibit different movements upon receiving a force, vibrations, or the like. Thus, in the configuration described above, a part having high support rigidity enough to support both the electric-equipment-housing case 50 and the controller-housing case 60 is unnecessary.

In general, since a DC electric generator has high output, the sizes of an electric-equipment-housing case and a controller-housing case for the DC electric generator as described in this embodiment are large. Thus, in enhancing versatility of the engine-driven-DC-supply unit, the electric-equipment-housing case, the controller-housing case, and a structure for supporting these cases tend to be an obstacle.

On the other hand, in the configuration described above, since a part having high support rigidity enough to support both the electric-equipment-housing case 50 and the controller-housing case 60 is unnecessary, parts supporting the electric-equipment-housing case 50 and the controller-housing case 60 can be downsized. Accordingly, the configuration of the engine-driven-DC-supply unit 300 including the electric-equipment-housing case 50 and the controller-housing case 60 can be made compact. Thus, in a case where the engine-driven-DC-supply unit 300 is mounted on the external load device 2, mountability to various types of external load devices 2 can be enhanced.

As illustrated in FIGS. 11A through 11C and 11G, in a configuration in which the electric-equipment-housing case 50 and the controller-housing case 60 of the engine-driven-DC-supply unit 300 are supported by the engine electric generator 20, the electric-equipment-housing case 50 and the controller-housing case 60 are elastically supported to the base member 10 through the elastic member 80. That is, the electric-equipment-housing case 50 is supported to the base member 10 by the electric-equipment-housing-case supporter 55 through the elastic member 80, and the controller-housing case 60 is supported to the base member 10 by the unillustrated controller-housing-case supporter through the elastic member 80. As illustrated in FIG. 11H, in the configuration in which the controller-housing case 60 is supported by the engine electric generator 20, the controller-housing case 60 is elastically supported to the base member 10 through the elastic member 80.

As illustrated in FIGS. 11E and 11F, in the configuration in which the electric-equipment-housing case 50 and the controller-housing case 60 are supported not to the engine electric generator 20 but to the base member 10, the electric-equipment-housing case 50 and the controller-housing case 60 are elastically unsupported to the base member 10. That is, the electric-equipment-housing case 50 is supported to the base member 10 by the electric-equipment-housing-case supporter 55 without use of the elastic member as an intermediary, and the controller-housing case 60 is supported to the base member 10 by the unillustrated controller-housing-case supporter without use of the elastic member as an intermediary.

In each of the cases described above, in the case where a force, vibrations, or the like is input to the electric-equipment-housing case 50 and the controller-housing case 60, the electric-equipment-housing case 50 and the controller-housing case 60 exhibit similar movements. Thus, although not particularly shown, the electric-equipment-housing case 50 and the controller-housing case 60 may be electrically connected directly to each other with a bus bar or the like.

As described above, in enhancing versatility of the engine-driven-DC-supply unit, the electric-equipment-housing case, the controller-housing case, or the like tend to be an obstacle.

On the other hand, with the configurations illustrated in FIGS. 11A through 11C, 11E, 11F, and 11G, a component housed in the electric-equipment-housing case 50 and a component housed in the controller-housing case 60 can be electrically connected to each other with a simple and compact structure. Thus, the configuration of the engine-driven-DC-supply unit 300 including the electric-equipment-housing case 50 and the controller-housing case 60 can be made compact. Thus, in the case of mounting the engine-driven-DC-supply unit 300 on the external load device 2, mountability to various types of external load devices 2 can be enhanced.

### Fifth Embodiment

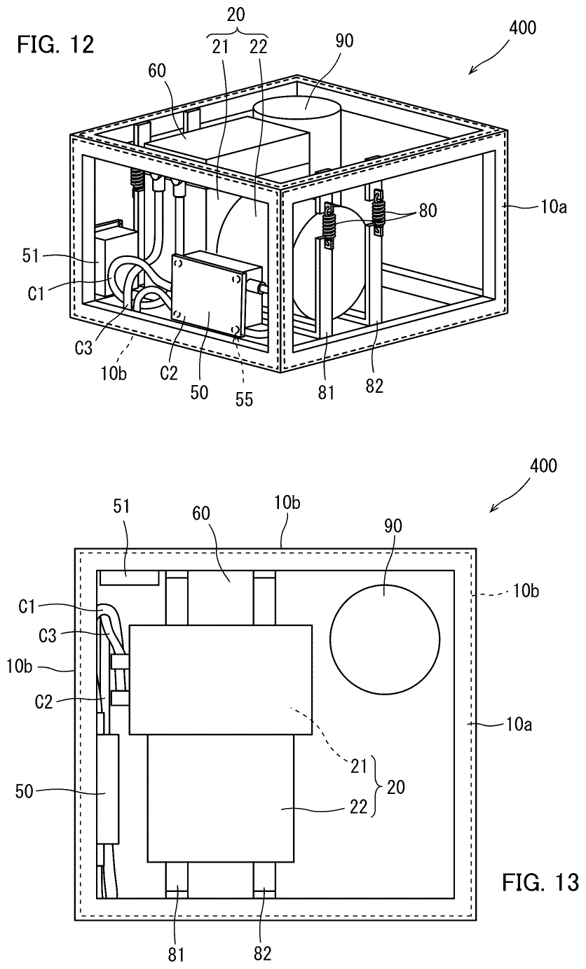

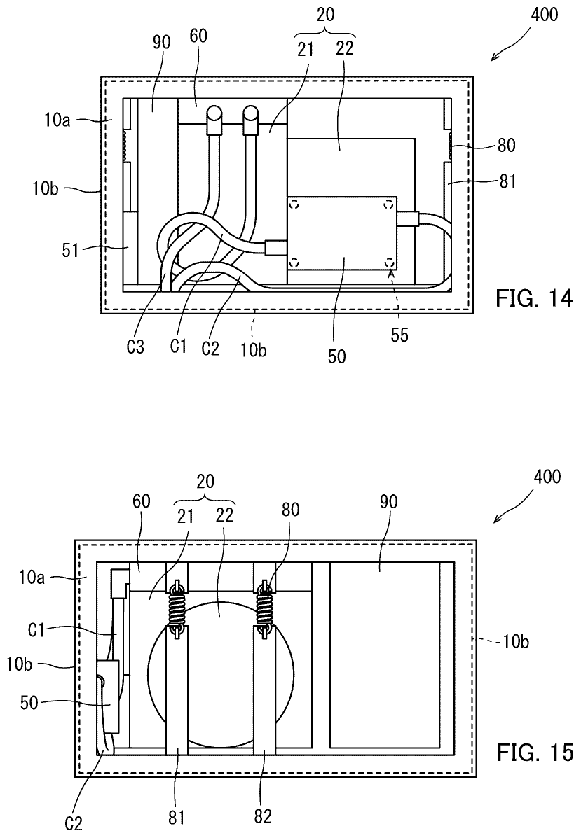

FIG. 12 is a perspective view illustrating a layout example of an engine-driven-DC-supply unit 400 according to a fifth embodiment. FIG. 13 is a top view of the engine-driven-DC-supply unit 400. FIG. 14 is a side view of the engine-driven-DC-supply unit 400. FIG. 15 is a front view of the engine-driven-DC-supply unit 400.

In this embodiment, an engine electric generator 20 is elastically supported by a support frame 10a constituting a part of a base member through an elastic member 80 and a pair of mount members 81 and 82. An electric-equipment-housing case 50 is fixed to walls 10b provided on the support frame 10a. In the following description, components similar to those of the second embodiment are denoted by the same reference signs and will not be described again, and only components different from those of the second embodiment will be described.

As illustrated in FIGS. 12 through 15, the engine-driven-DC-supply unit 400 includes the support frame 10a, the walls 10b, an engine electric generator 20, an electric-equipment-housing case 50, a controller-housing case 60, the elastic members 80, the pair of mount members 81 and 82, and a muffler 90.

The support frame 10a has a rectangular parallelepiped shape by combining frame-shaped members. The walls 10b are provided on the support frame 10a to constitute faces of the rectangular parallelepiped. That is, the engine-driven-DC-supply unit 400 has six walls 10b. In this embodiment, the support frame 10a and the walls 10b constitute a base member. In FIGS. 12 through 15, the walls 10b are indicated by broken lines for description.

The engine-driven-DC-supply unit may have five or less walls. That is, the walls may be disposed on the frame to constitute a part of the rectangular parallelepiped.

The engine electric generator 20 is supported by the pair of mount members 81 and 82 connected to the support frame 10a through the elastic members 80. Each of the pair of mount members 81 and 82 includes a bottom extending in parallel with an axis of a crankshaft of an engine 21, and a pair of connection portions extending upward from the ends of the bottom in the longitudinal direction. The pair of mount members 81 and 82 is arranged in a direction orthogonal to the axis of the crankshaft in a plan view of the engine-driven-DC-supply unit 400.

The elastic members 80 are, for example, a tension spring. The elastic members may be a member other than the tension spring as long as the elastic members have an elastically deformable structure. Upper portions of connection portions of the pair of mount members 81 and 82 are connected to one ends of the elastic members 80. The other ends of the elastic members 80 are connected to the support frame 10a.

The engine electric generator may be connected to the frame by one or three or more mount members. A support structure of the engine electric generator 20 to the support frame 10a may be a structure other than the structure described above. An engine electric generator unit may be directly connected to the frame, for example.

The electric-equipment-housing case 50 is fixed to the inner surfaces of the walls 10b. In this embodiment, the electric-equipment-housing case 50 is fixed to the walls 10b with, for example, bolts. Thus, the electric-equipment-housing-case supporter 55 according to this embodiment include attachment holes formed in the walls 10b. The electric-equipment-housing-case supporter may include a fixing seat, a coupling member such as a bolt, an attachment, an uneven portion for engagement, and so forth.

In this embodiment, the electric-equipment-housing case 50 houses a relay circuit 52 including a precharge circuit 53, and external communication equipment 70. A DC-to-DC converter 51 is attached to an inner surface of the wall 10b different from the wall 10b to which the electric-equipment-housing case 50 is attached.

In this embodiment, the electric-equipment-housing case 50 and the controller-housing case 60 are electrically connected to each other by a distribution cable C1. A distribution cable C2 electrically connected to the electric-equipment-housing case 50 extends to the outside of the engine-driven-DC-supply unit 400 and is electrically connected to the external load device 2, for example. A distribution cable C3 electrically connected to the controller-housing case 60 extends to the outside of the engine-driven-DC-supply unit 400 and is electrically connected to the external load device 2, for example.

The electric-equipment-housing case 50 houses at least one of the relay circuit 52, the DC-to-DC converter 51, or the external communication equipment 70 to avoid an overlap of functions of the relay circuit 52, the DC-to-DC converter 51, and the external communication equipment 70 depending on the state where the relay circuit 52, the DC-to-DC converter 51, and the external communication equipment 70 are mounted on the external load device 2.

The electric-equipment-housing case 50 may house only the relay circuit 52. The electric-equipment-housing case 50 may house only the external communication equipment 70. The electric-equipment-housing case 50 may house only the DC-to-DC converter 51. The electric-equipment-housing case 50 may house the relay circuit 52 and the DC-to-DC converter 51. The electric-equipment-housing case 50 may house the DC-to-DC converter 51 and the external communication equipment 70. The electric-equipment-housing case 50 may house the relay circuit 52, the DC-to-DC converter 51, and the external communication equipment 70.

The engine-driven-DC-supply unit 400 may be without the electric-equipment-housing case 50.

In this embodiment, the electric-equipment-housing-case supporter 55 is disposed on the walls 10b as a part of the base member to support the electric-equipment-housing case 50 at a position that is without hindering attachment and detachment of the base member to/from the external load device 2.

Accordingly, the electric-equipment-housing-case supporter 55 supports the electric-equipment-housing case 50 without hindering attachment and detachment of the base member to/from the external load device 2. Thus, it is possible to obtain the engine-driven-DC-supply unit 400 with enhanced mountability to various types of external load devices 2.

### Other Embodiments

The embodiments of the present teaching have been described above, but the embodiments are merely examples for carrying out the present teaching. Thus, the present teaching is not limited to the embodiments described above, and the embodiments may be modified as necessary within a range not departing from the gist of the present teaching.

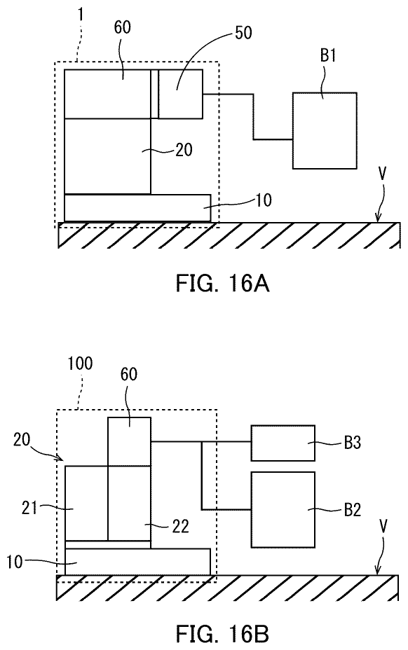

In the first embodiment, the battery B is mounted on the vehicle V as an example of an external load device. Alternatively, the battery may be unmounted on the mobile object. That is, as illustrated in FIG. 16A, a battery B1 unmounted on the vehicle V may be electrically connected to the engine-driven-DC-supply unit 1 in which components are arranged as illustrate in FIG. 6A. In this case, the DC-to-DC converter 51 and the relay circuit 52 housed in the electric-equipment-housing case 50 are electrically connected to the battery B1 unmounted on the vehicle V. The battery BI corresponds to the external load device.

As illustrated in FIG. 16B, batteries B2 and B3 unmounted on the vehicle V may be electrically connected to the engine-driven-DC-supply unit 100 without the electric-equipment-housing case 50. The batteries B2 and B3 are batteries at different voltages. The batteries B2 and B3 include, for example, a battery electrically connected to the electric power converter and a battery electrically connected to the controller and other components. Thus, in the example illustrated in FIG. 16B, the DC-to-DC converter is unnecessary, and the batteries B2 and B3 unmounted on the vehicle V are electrically connected to the electric power converter 30 and the controller 40 housed in the controller-housing case 60. The batteries B2 and B3 correspond to the external load device.

The structures as illustrated in FIGS. 16A and 16B described above may be applied to the engine-driven-DC-supply unit 1 having layout as illustrated in each of FIGS. 6B through 6H. The structures illustrated in FIGS. 16A and 16B may also be applied to an engine-driven-DC-supply unit having a configuration other than those illustrated in FIG. 6.

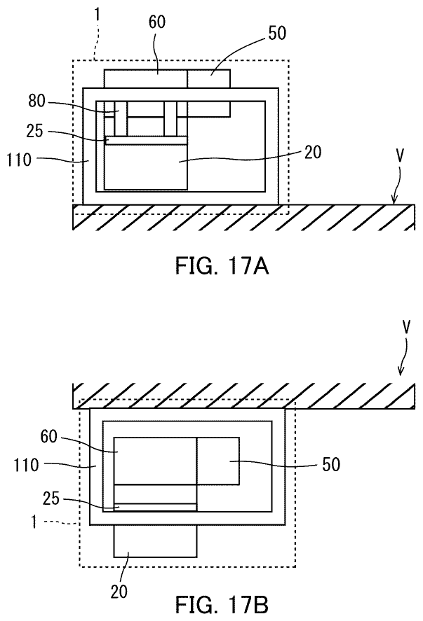

In the foregoing embodiments, the engine-driven-DC-supply unit 1, 100, 200, 300, or 400 includes the base member 10. The engine electric generator 20 is disposed on the base member 10. However, as illustrated in FIGS. 17A and 17B, the engine electric generator 20 may hang on the base member 110. The base member 110 may be attached to an upper portion of the vehicle V as an example of the external load device 2 as illustrated in FIG. 17A, or may be attached to a lower portion of the vehicle V as an example of the external load device 2 as illustrated in FIG. 17B.

In the examples illustrated in FIGS. 17A and 17B, the engine electric generator 20 includes an attachment portion 25 that is connected to the base member 110. In the example illustrated in FIG. 17A, the attachment portion 25 is connected to the base member 110 through the elastic member 80 such as a spring. In the example illustrated in FIG. 17B, the attachment portion 25 is connected to the base member 110 through an unillustrated elastic member such as rubber.

In FIGS. 17A and 17B, the example is applied to layout of the engine-driven-DC-supply unit 1 illustrated in FIG. 6A. Alternatively, the configurations illustrated in FIGS. 17A and 17B may be applied to the layouts of the engine-driven-DC-supply unit 1 illustrated in FIGS. 6B through 6H.

In the embodiments, the engine-driven-DC-supply unit 1, 100, 200, 300, or 400 is attached to the vehicle V as an example of the mobile object. Alternatively, the engine-driven-DC-supply unit may be used as a power generating unit alone.

In the fourth embodiment, the engine electric generator 20 is supported to the base member 10 through the elastic member 80. Alternatively, the engine-driven-DC-supply unit may include a member supporting the electric-equipment-housing case and supported to the base member through the elastic member, or may include a member supported by a control portion box and supported to the base member through the elastic member, as well as the engine electric generator.

As described above, the state where the electric-equipment-housing case is supported through the elastic member includes a case where a member other than the engine electric generator is supported to the base member by the elastic member and supports the electric-equipment-housing case. Thus, in the case where the electric-equipment-housing case is supported through the elastic member, it is sufficient that the elastic member is located on a vibration transfer path between the base member and the electric-equipment-housing case. The state where the controller-housing case is supported through the elastic member includes a case where a member other than the engine electric generator is supported to the base member by the elastic member and supports the controller-housing case. Thus, in the case where the controller-housing case is supported through the elastic member, it is sufficient that the elastic member is located on a vibration transfer path between the base member and the controller-housing case.

### REFERENCE SIGNS LIST

1, 100, 200, 300, 400 engine-driven-DC-supply unit
2 external load device
B, B1, B2, B3 battery (electric power storage)
3 switch
4 load
5 electric-power controller (external-load-device controller)
10, 110 base member
10a support frame
10b wall
20 engine electric generator
21 engine
22 electric generator
25 attachment portion
30 electric power converter
40 controller
50 electric-equipment-housing case
51 DC-to-DC converter
52 relay circuit
53 precharge circuit
53a precharge relay
53b resistor
54 main relay
55 electric-equipment-housing-case supporter
60 controller-housing case
65 controller-housing-case supporter
70 external communication equipment
80 elastic member
81, 82 mount member
90 muffler
V vehicle (mobile object)
W wheel
C1, C2, C3 distribution cable

1. An engine-driven-DC-supply unit comprising:
an electric generator;
an engine that drives the electric generator to generate electric power;
an electric power converter that converts the electric power generated by the electric generator to DC power, and outputs the DC power to an external load device located outside the engine-driven-DC-supply unit;
a controller that controls at least one of the electric power converter or the engine;
a controller-housing case that houses at least the controller;
a base member that directly or indirectly supports the electric generator, the engine, the electric power converter, and the controller; and
an electric-equipment-housing-case supporter disposed in at least one of the electric generator, the engine, the controller-housing case, or the base member, wherein
the engine-driven-DC-supply unit supplies the DC power to the external load device without providing mechanical power for driving the external load device,
the electric-equipment-housing-case supporter supports an electric-equipment-housing case that is configured as a case different from the controller-housing case and houses electric equipment electrically connected to the controller, the electric equipment being at least one of a relay circuit including a precharge circuit, a DC-to-DC converter that converts the DC power to DC power of a different voltage, or external communication equipment configured to communicate with another external equipment different from the engine-driven-DC-supply unit and the external load device by wireless connection or wired connection,
the electric-equipment-housing-case supporter is so disposed that the electric-equipment-housing case is supported to be free of contact with the external load device, in a case where the engine-driven-DC-supply unit is electrically connected to the external load device, and
each of the relay circuit, the DC-to-DC converter and the external communication equipment is disposed entirely either in the electric-equipment-housing case or on the external load device.

2. The engine-driven-DC-supply unit according to claim 1, wherein
the engine-driven-DC-supply unit supplies the DC power to an electric power storage or an electrical load included in the external load device.

3. The engine-driven-DC-supply unit according to claim 2, wherein
each of the electric power storage and the electrical load is supported by the external load device, without being supported by the base member.

4. The engine-driven-DC-supply unit according to claim 1, further comprising an external-load-device controller that controls the electric equipment mounted on the external load device, the external-load-device controller being unsupported by the base member.

5. The engine-driven-DC-supply unit according to claim 1, wherein
the controller has both an engine control function of controlling the engine and an electric-power-conversion-controlling function of controlling the electric power converter, and is housed in the controller-housing case,
the engine-driven-DC-supply unit further comprises a controller-housing-case supporter supporting the controller-housing case, and
the electric-equipment-housing case is connected to the base member by the electric-equipment-housing-case supporter through an elastic member, and the controller-housing case is connected to the base member by the controller-housing-case supporter without using the elastic member as an intermediary thereof, or
the electric-equipment-housing case is connected to the base member by the electric-equipment-housing-case supporter without using the elastic member as an intermediary thereof, and the controller-housing case is connected to the base member by the controller-housing-case supporter through the elastic member.

6. The engine-driven-DC-supply unit according to claim 1, wherein
the controller has both an engine control function of controlling the engine and an electric-power-conversion-controlling function of controlling the electric power converter, and is housed in the controller-housing case,
the engine-driven-DC-supply unit further comprises a controller-housing-case supporter supporting the controller-housing case, and
the electric-equipment-housing case is connected to the base member by the electric-equipment-housing-case supporter through an elastic member, and the controller-housing case is connected to the base member by the controller-housing-case supporter through the elastic member, or
the electric-equipment-housing case is connected to the base member by the electric-equipment-housing-case supporter without using the elastic member as an intermediary thereof, and the controller-housing case is connected to the base member by the controller-housing-case supporter without using the elastic member as an intermediary thereof.

7. The engine-driven-DC-supply unit according to claim 1, wherein
the electric-equipment-housing-case supporter is so disposed that the electric-equipment-housing case is supported at a position that is without hindering attachment and detachment of the base member to/from the external load device in a case where the engine-driven-DC-supply unit is attached to the external load device.

8. The engine-driven-DC-supply unit according to claim 1, further comprising a controller-housing-case supporter disposed in at least one of the electric generator, the engine, or the base member such that the controller-housing case is supported at a position at which the controller-housing case is free of contact with the external load device in a case where the engine-driven-DC-supply unit is attached to the external load device, wherein
the electric-equipment-housing-case supporter is so disposed that the electric-equipment-housing case is supported at a position at which the electric-equipment-housing case is attachable to and detachable from the electric-equipment-housing-case supporter even in a state where the controller-housing-case supporter supports the controller-housing case.
